(19) United States
(12) Patent Application Publication
(10) Pub. No.: US 2026/0275104 A1
(43) Pub. Date: Sep. 17, 2026

(54) Thermoplastic Resin Composition and Molded Article Manufactured Therefrom

(71) Applicant: LOTTE CHEMICAL CORPORATION, Seoul (KR)

(72) Inventors: Dong In HA, Uiwang-si (KR); Tae Gon KANG, Uiwang-si (KR); Su Ji KIM, Uiwang-si (KR); Sung Woo YANG, Uiwang-si (KR); Seo Yun LEE, Uiwang-si (KR)

(21) Appl. No.: 19/167,964

(22) PCT Filed: Jan. 18, 2024
(86) PCT No.: PCT/KR2024/095031

§ 371 Date: Sep. 23, 2025

(30) Foreign Application Priority Data
Mar. 31, 2023 (KR) 10-2023-0042391

(51) Int. Cl. C08L 69/00; C08K 3/34; C08K 5/521; C08K 5/5399; C08K 7/14

(52) U.S. Cl. CPC C08L 69/00; C08K 3/346; C08K 5/521; C08K 5/5399; C08K 7/14; C08K 2201/003; C08K 2201/004; C08K 2201/016; C08L 2201/02; C08L 2203/206

(57) ABSTRACT

A thermoplastic resin composition of the present invention comprises: about 100 parts by weight of a polycarbonate resin; about 0.5 to 15 parts by weight of a polyester resin; about 1 to 20 parts by weight of a phosphate compound; about 1 to 15 parts by weight of a phosphazene compound; about 1 to 15 parts by weight of talc having an average particle size (D50) of about 7 to 20 μm; about 10 to 40 parts by weight of flat plate-shaped glass fiber; and about 1 to 20 parts by weight of mica having an average particle size (D50) of about 250 to 450 μm. The thermoplastic resin composition has excellent flame retardancy, dimensional stability, isotropy, impact resistance, rigidity, exterior characteristics, etc.

### TECHNICAL FIELD

The present invention relates to a thermoplastic resin composition and a molded article formed therefrom. More particularly, the present invention relates to a thermoplastic resin composition that has good properties in terms of flame retardancy, dimensional stability, isotropy, impact resistance, rigidity, appearance characteristics, and the like, and a molded article formed therefrom.

### BACKGROUND ART

As engineering plastics, polycarbonate resins have good properties in terms of impact resistance, heat resistance, dimensional stability, weather resistance, flame retardancy, electrical properties, transparency, and the like, and are usefully applied to housings of electric/electronic products, interior/exterior materials of office equipment, and the like. In addition, various fillers may be applied thereto to enhance various properties.

However, fillers, such as glass fibers, talc, mica, wollastonite, and the like, which are used to improve dimensional stability and rigidity of a polycarbonate resin, have different physical properties depending on the type, can suffer from deterioration in appearance characteristics due to protrusion of the fillers and the like, and can cause deterioration in physical properties when added in an excessive amount.

Therefore, there is a need for development of a thermoplastic resin composition having good properties in terms of flame retardancy, dimensional stability, isotropy, impact resistance, rigidity, appearance characteristics, and the like without suffering from such problems.

The background technique of the present invention is disclosed in Korean Patent Laid-open Publication No. 10-2011-0059886 and the like.

### DISCLOSURE

### Technical Problem

It is an object of the present invention to provide a thermoplastic resin composition with good properties in terms of flame retardancy, dimensional stability, isotropy, impact resistance, rigidity, appearance characteristics, and the like.

It is another object of the present invention to provide a molded article formed of the thermoplastic resin composition.

The above and other objects of the present invention can be achieved by embodiments of the present invention described below.

### Technical Solution

1. One aspect of the present invention relates to a thermoplastic resin composition. The thermoplastic resin composition comprises: about 100 parts by weight of a polycarbonate resin; about 0.5 parts by weight to about 15 parts by weight of a polyester resin; about 1 part by weight to about 20 parts by weight of a phosphate compound; about 1 part by weight to about 15 parts by weight of a phosphazene compound; about 1 part by weight to about 15 parts by weight of talc having an average particle diameter (D50) of about 7 μm to about 20 μm; about 10 parts by weight to about 40 parts by weight of flat plate type glass fibers; and about 1 part by weight to about 20 parts by weight of mica having an average particle diameter (D50) of about 250 μm to about 450 μm.
2. In embodiment 1, the polyester resin may comprise at least one of polyethylene terephthalate, polybutylene terephthalate, polyethylene naphthalate, polytrimethylene terephthalate, and polycyclohexylene terephthalate.
3. In embodiment 1 or 2, the flat plate type glass fibers may have a cross-section aspect ratio (long-side length in cross-section/short-side length in cross-section) of about 1.5 to about 10, a cross-section diameter of about 2 μm to about 10 μm, and a pre-processing length of about 1 mm to about 30 mm.
4. In embodiments 1 to 3, the phosphate compound and the phosphazene compound may be present in a weight ratio of about 1:0.3 to about 1:2.
5. In embodiments 1 to 4, the talc and the flat plate type glass fibers may be present in a weight ratio of about 1:2 to about 1:8.
6. In embodiments 1 to 5, the talc and the mica may be present in a weight ratio of about 1:0.5 to about 1:2.
7. In embodiments 1 to 6, the flat plate type glass fibers and the mica may be present in a weight ratio of about 1:0.1 to about 1:0.6.
8. In embodiments 1 to 7, the thermoplastic resin composition may have a flame retardancy of V-0 or higher, as measured on a 1.5 mm thick injection-molded specimen by the UL-94 vertical test method.
9. In embodiments 1 to 8, the thermoplastic resin composition may have a coefficient of linear expansion of about 15 μm/m·° C. to about 36 μm/m·° C., as measured on an injection-molded specimen having a size of 10 mm×10 mm×3.2 mm while increasing temperature from −20° C. to 100° C. at 5° C./min in accordance with ASTM D696.
10. In embodiments 1 to 9, the thermoplastic resin composition may have an isotropy of about 1.1 to about 1.3, as calculated according to Equation 1.

$$Isotropy = Coefficient of TD linear expansion / Coefficient of MD linear expansion , \qquad [ Equation 1 ]$$

where the coefficient of TD linear expansion is a value measured on an injection-molded specimen having a size of 10 mm×10 mm×3.2 mm in a transverse direction (TD) and the coefficient of MD linear expansion is a value measured on the specimen in a machine direction (MD) while increasing temperature from −20° C. to 100° C. at 5° C./min in accordance with ASTM D696.
11. In embodiments 1 to 10, the thermoplastic resin composition may have a notched Izod impact strength of about 5 kgf cm/cm to about 20 kgf cm/cm, as measured on a ⅛″ thick specimen in accordance with ASTM D256.
12. In embodiments 1 to 11, the thermoplastic resin composition may have a flexural modulus of about 70,000 kgf/cm² to about 140,000 kgf/cm², as measured on a 6.4 mm thick specimen at 2.8 mm/min in accordance with ASTM D790.
13. Another aspect of the invention relates to a molded article. The molded article is formed of a thermoplastic resin composition according to any one of embodiments 1 to 12.
14. In embodiment 13, the molded article may be a plastic member of an electronic device housing comprising a metal frame and a plastic member adjoining at least one surface of the metal frame.

### Advantageous Effects

The present invention provides a thermoplastic resin composition with good properties in terms of flame retardancy, dimensional stability, isotropy, impact resistance, rigidity, appearance characteristics, and the like, and a molded article formed of the same.

### DESCRIPTION OF DRAWINGS

FIG. 1 is a schematic cross-sectional view of an electronic device housing according to one embodiment of the present invention.

### BEST MODE

Hereinafter, embodiments of the present invention will be described in detail.

The thermoplastic resin compositions according to the present invention includes (A) a polycarbonate resin; (B) a polyester resin; (C) a phosphate compound; (D) a phosphazene compound; (E) talc; (F) flat plate type glass fibers; and (G) mica.

As used herein to represent a specific numerical range, “a to b” is defined as “≥a and ≤b”.

### (A) Polycarbonate Resin

The polycarbonate resin according to one embodiment of the invention may include a polycarbonate resin used in typical thermoplastic resin compositions. For example, the polycarbonate resin may be an aromatic polycarbonate resin prepared by reacting diphenols (aromatic diol compounds) with a precursor, such as phosgene, halogen formate, or carbonate diester.

In some embodiments, the diphenols may include, for example, 4,4′-biphenol, 2,2-bis(4-hydroxyphenyl)-propane, 2,4-bis(4-hydroxyphenyl)-2-methylbutane, 1,1-bis(4-hydroxyphenyl)cyclohexane, 2,2-bis(3-chloro-4-hydroxyphenyl) propane, 2,2-bis-(3,5-dichloro-4-hydroxyphenyl) propane, without being limited thereto. For example, the diphenols may be 2,2-bis(4-hydroxyphenyl) propane, 2,2-bis(3,5-dichloro-4-hydroxyphenyl) propane, or 1,1-bis(4-hydroxyphenyl)cyclohexane, specifically 2,2-bis(4-hydroxyphenyl) propane, which is also referred to as bisphenol-A.

In some embodiments, the polycarbonate resin may be a branched polycarbonate resin. For example, the polycarbonate resin may be a polycarbonate resin prepared by adding a tri- or higher polyfunctional compound, specifically, a tri- or higher valent phenol group-containing compound, in an amount of about 0.05 mol % to about 2 mol % based on the total number of moles of the diphenols used in polymerization.

In some embodiments, the polycarbonate resin may be a homopolycarbonate resin, a copolycarbonate resin, or a blend thereof. In addition, the polycarbonate resin may be partially or completely replaced by an aromatic polyester-carbonate resin prepared by polymerization in the presence of an ester precursor, for example, a bifunctional carboxylic acid

In some embodiments, the polycarbonate resin may have a weight average molecular weight (Mw) of about 10,000 g/mol to about 200,000 g/mol, for example, about 15,000 g/mol to about 80,000 g/mol, as measured by gel permeation chromatography (GPC). Within this range, the thermoplastic resin composition can have good fluidity (processability), and the like.

### (B) Polyester Resin

The polyester resin according to one embodiment of the invention may applied to the polycarbonate resin together with the phosphate compound, the phosphazene compound, the talc, the flat plate type glass fibers, the mica, and the like to improve flame retardancy, dimensional stability, isotropy, impact resistance, rigidity, appearance characteristics, property balance therebetween, and the like of the thermoplastic resin composition, and may be a polyester resin used in typical thermoplastic resin compositions. For example, the polyester resin may be prepared by polycondensation of a dicarboxylic acid component with a diol component, wherein the dicarboxylic acid component may include aromatic dicarboxylic acids, such as terephthalic acid (TPA), isophthalic acid (IPA), 1,2-naphthalene dicarboxylic acid, 1,4-naphthalene dicarboxylic acid, 1,5-naphthalene dicarboxylic acid, 1,6-naphthalene dicarboxylic acid, 1,7-naphthalene dicarboxylic acid, 1,8-naphthalene dicarboxylic acid, 2,3-naphthalene dicarboxylic acid, 2,6-naphthalene dicarboxylic acid, 2,7-naphthalenedicarboxylic acid and the like, aromatic dicarboxylates, such as dimethyl terephthalate (DMT), dimethyl isophthalate, dimethyl-1,2-naphthalate, dimethyl-1,5-naphthalate, dimethyl-1,7-naphthalate, dimethyl-1,8-naphthalate, dimethyl-2,3-naphthalate, dimethyl-2,6-naphthalate, dimethyl-2,7-naphthalate, and the like; and the diol component may include ethylene glycol, 1,2-propylene glycol, 1,3-propylene glycol, 2,2-dimethyl-1,3-propanediol, 1,3-butanediol, 1,4-butanediol, 1,5-pentanediol, 1,5-pentanediol, 1,6-hexanediol, a cycloalkylene diol, and the like.

In some embodiments, the polyester resin may comprise at least one of polyethylene terephthalate (PET), polybutylene terephthalate (PBT), polyethylene naphthalate (PEN), polytrimethylene terephthalate (PTT), and polycyclohexylene terephthalate. For example, the polyester resin may be polyethylene terephthalate, polybutylene terephthalate, a combination thereof, or the like.

In some embodiments, the polyester resin of the present invention may have an intrinsic viscosity of about 0.6 dl/g to about 1.5 dl/g, for example, about 0.7 dl/g to about 1.3 dl/g, as measured on a specimen using an Ubbelohde viscometer (capillary viscometer) at 25° C., in which the specimen is prepared by dissolving the polyester resin in an o-chlorophenol solution (concentration: 0.5 g/dl). Within this range, the thermoplastic resin composition can have good properties in terms of processability, dimensional stability, and the like.

In some embodiments, the polyester resin may be present in an amount of about 0.5 to about 15 parts by weight, for example, about 1 to about 10 parts by weight, relative to about 100 parts by weight of the polycarbonate resin. If the content of the polyester resin is less than about 0.5 parts by weight relative to about 100 parts by weight of the polycarbonate resin, the thermoplastic resin composition (molded product) can suffer from deterioration in dimensional stability, isotropy, and the like, and if the content of the polyester resin exceeds about 15 parts by weight, the thermoplastic resin composition (molded product) can suffer from deterioration in flame retardancy, isotropy, impact resistance, and the like.

### (C) Phosphate Compound

The phosphate compound according to one embodiment of the present invention may be applied to the polycarbonate resin together with the polyester resin, the phosphazene compound, the talc, the flat plate type glass fibers, the mica, and the like to improve flame retardancy, dimensional stability, isotropy, impact resistance, rigidity, appearance characteristics, property balance therebetween, and the like of the thermoplastic resin composition, and may be a phosphate compound used in typical flame retardant thermoplastic resin compositions.

In some embodiments, the phosphate compound may include diaryl phosphate, such as diphenyl phosphate and the like, triphenyl phosphate, tricresyl phosphate, trixylenyl phosphate, tri (2,6-dimethylphenyl) phosphate, tri (2,4,6-trimethylphenyl) phosphate, tri (2,4-di-tert-butylphenyl) phosphate, tri (2,6-dimethylphenyl) phosphate, bisphenol-A bis(diphenyl phosphate), resorcinol bis(diphenyl phosphate), resorcinol bis [bis(2,6-dimethylphenyl) phosphate], resorcinol bis [bis(2,4-di-tert-butylphenyl) phosphate], hydroquinone bis [bis(2,6-dimethylphenyl) phosphate], hydroquinone bis [bis(2,4-di-tert-butylphenyl) phosphate], and the like. These may be used alone or as a mixture thereof. For example, the phosphate compound may be an oligomer type bisphenol-A diphosphate or the like.

In some embodiments, the phosphate compound may be present in an amount of about 1 to about 20 parts by weight, for example, about 5 to about 15 parts by weight, relative to about 100 parts by weight of the polycarbonate resin. If the content of the phosphate compound is less than about 1 part by weight relative to about 100 parts by weight of the polycarbonate resin, the thermoplastic resin composition can suffer from deterioration in flame retardancy, appearance characteristics (injection moldability), and the like, and if the content of the phosphate compound exceeds about 20 parts by weight, the thermoplastic resin composition can suffer from deterioration in isotropy, impact resistance, and the like.

### (D) Phosphazene Compound

The phosphazene compound according to one embodiment of the invention may be applied to the polycarbonate resin together with the polyester resin, the phosphate compound, the phosphazene compound, the talc, the flat plate type glass fibers, the mica, and the like to improve flame retardancy, dimensional stability, isotropy, impact resistance, rigidity, appearance characteristics, property balance therebetween, and the like of the thermoplastic resin composition, and may be a phosphazene compound used in typical flame retardant thermoplastic resin compositions.

In some embodiments, the phosphazene compound may include a phosphazene compound represented by Formula 1.

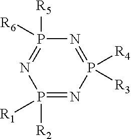

In Formula, R₁, R₂, R₃, R₄, R₅ and R₆ are each independently a hydrogen atom, a halogen atom, a substituted or unsubstituted C₁ to C₂₀ alkyl group, a substituted or unsubstituted C₂ to C₇ alkenyl group, a substituted or unsubstituted C₃ to C₂₀ cycloalkyl group, a substituted or unsubstituted C₂ to C₂₀ heterocycloalkyl group, a C₁ to C₂₀ alkoxy group, a C₆ to C₂₀ aryl or aryloxy group, a C₅ to C₂₀ heteroaryl group, a substituted or unsubstituted C₃ to C₂₀ alkoxycarbonylalkyl group, a substituted or unsubstituted a C₂ to C₂₀ carbonylalkyl group, an amino group, or a hydroxyl group.

Herein, “substituted” means that a hydrogen atom is substituted with a substituent, such as a C₁ to C₁₀ alkyl group, a halogen atom, a nitro group, a cyano group, a hydroxyl group, an amino group, a C₆ to C₁₀ aryl group, a C₃ to C₁₀ cycloalkyl group, a C₃ to C₁₀ heterocycloalkyl group, a C₄ to C₁₀ heteroaryl group, or a combination thereof.

In addition, “alkyl,” “alkoxy,” and other “alkyl” moiety-containing substituents include both linear and branched forms, “alkenyl” includes both linear and branched forms having 2 to 8 carbon atoms and containing at least one double bond, and “cycloalkyl” includes both saturated monocyclic and saturated bicyclic ring structures having 3 to 20 carbon atoms. In addition, “aryl” refers to a cyclic organic radical derived from an aromatic hydrocarbon by removal of one hydrogen atom and includes single or fused ring systems in which each ring suitably contains 4 to 7, preferably 5 or 6, skeletal atoms. Specific examples of “aryl” may include phenyl, naphthyl, biphenyl, tolyl, and the like.

In addition, “heterocycloalkyl” refers to a cycloalkyl group containing 1 to 3 heteroatoms selected from among N, O, and S as a skeletal atom of a saturated cyclic hydrocarbon structure and containing carbon as remaining skeletal atoms of a saturated monocyclic or bicyclic ring structure, and may include, for example, pyrrolidinyl, azetidinyl, pyrazolidinyl, oxazolidinyl, piperidinyl, piperazinyl, morpholinyl, thiomorpholinyl, thiazolidinyl, hydantoinyl, valerolactamyl, oxiranyl, oxetanyl, dioxolanyl, dioxanyl, oxathiolanyl, oxathianyl, dithianyl, dihydrofuranyl, tetrahydrofuranyl, dihydropyranyl, tetrahydropyranyl, tetrahydropyridinyl, tetrahydropyrimidinyl, tetrahydrothiophenyl, tetrahydrothiopyranyl, diazepanyl, azepanyl, and the like.

In addition, “heteroaryl” refers to an aryl group containing 1 to 3 heteroatoms selected from among N, O, and S as a skeletal atom of an aromatic ring structure and containing carbon as remaining skeletal atoms of the aromatic ring structure. The heteroaryl group includes divalent aryl groups in which a heteroatom in the ring structure is oxidized or quaternized to form, for example, an N-oxide or a quaternary salt. Specific examples of “heteroaryl” may include furyl, thienyl, pyrrolyl, pyranyl, imidazolyl, pyrazolyl, thiazolyl, thiadiazolyl, isothiazolyl, isoxazolyl, oxazolyl, oxadiazolyl, triazinyl, tetrazinyl, triazolyl, tetrazolyl, furazanyl, pyridyl, pyrazinyl, pyrimidinyl, pyridazinyl, and the like.

In some embodiments, the phosphazene compound may be present in an amount of about 1 to about 15 parts by weight, for example, about 5 to about 10 parts by weight, relative to about 100 parts by weight of the polycarbonate resin. If the content of the phosphazene compound is less than about 1 part by weight relative to about 100 parts by weight of the above polycarbonate resin, the thermoplastic resin composition can suffer from deterioration in flame retardancy and the like, and if the content of the phosphazene compound exceeds about 15 parts by weight, the thermoplastic resin composition can suffer from deterioration in isotropy, impact resistance, and the like.

In some embodiments, the phosphate compound and the phosphazene compound may be present in a weight ratio (phosphate compound:phosphazene compound) of about 1:0.3 to about 1:2, for example, about 1:0.4 to about 1:1.7. Within this range, the thermoplastic resin composition can have better flame retardancy, and the like.

### (E) Talc

The talc according to one embodiment of the present invention may be applied to the polycarbonate resin together with the polyester resin, the phosphate compound, the phosphazene compound, the flat plate type glass fibers, the mica, and the like to improve flame retardancy, dimensional stability, isotropy, impact resistance, rigidity, appearance characteristics, property balance therebetween, and the like of the thermoplastic resin composition, and may be talc having an average particle diameter (D50) of about 7 μm to about 20 μm.

In some embodiments, the talc refers to flake type fillers and has an average particle diameter (D50) of about 7 μm to about 20 μm, for example, about 8 μm to about 14 μm, as measured by a laser particle size analyzer (manufacturer: Beckman Coulter, device name: LS 13 320). If the average particle diameter (D50) of the talc is less than about 7 μm, the thermoplastic resin composition can suffer from deterioration in dimensional stability, impact resistance, and the like, and if the average particle diameter of the talc exceeds about 20 μm, the thermoplastic resin composition can suffer from deterioration in impact resistance, appearance characteristics, and the like.

In some embodiments, the talc may be present in an amount of about 1 to about 15 parts by weight, for example, about 5 to about 10 parts by weight, relative to about 100 parts by weight of the polycarbonate resin. If the content of the talc is less than about 1 part by weight relative to about 100 parts by weight of the polycarbonate resin, the thermoplastic resin composition can suffer from deterioration in isotropy and the like, and if the content of the talc exceeds about 15 parts by weight, the thermoplastic resin composition can suffer from deterioration in flame retardancy, impact resistance, and the like.

### (F) Flat Plate Type Glass Fiber

The flat type glass fibers according to one embodiment of the present invention may be applied to the polycarbonate resin together with the polyester resin, the phosphate compound, the phosphazene compound, the phosphazene compound, the talc, and the mica, and the like to improve flame retardancy, dimensional stability, isotropy, impact resistance, rigidity, appearance characteristics, property balance therebetween, and the like of the thermoplastic resin composition.

In some embodiments, the flat plate type glass fibers may have a rectangular cross-section. For example, the flat plate type glass fibers may have a cross-sectional aspect ratio (long-side length in cross-section/short-side length in cross-section) of about 1.5 to about 10, for example, about 2 to about 8, a short-side length of about 2 μm to about 10 μm, for example, about 4 μm to about 8 μm, and a pre-processing length of about 1 mm to about 5 mm, for example, about 2 mm to about 4 mm, as measured by a scanning electron microscope (manufacturer: JEOL, Product name: JSM-6390A). Within these ranges, the thermoplastic resin composition can have good rigidity, appearance characteristics, and the like.

In some embodiments, the flat plate type glass fibers may be treated with a typical surface treatment agent.

In some embodiments, the flat plate type glass fibers may be present in an amount of about 10 to about 40 parts by weight, for example, about 20 to about 40 parts by weight, relative to about 100 parts by weight of the polycarbonate resin. If the content of the flat plate type glass fibers is less than about 10 parts by weight relative to about 100 parts by weight of the polycarbonate resin, the thermoplastic resin composition can suffer from deterioration in dimensional stability, isotropy, rigidity, and the like, and if the content of the flat plate type glass fibers exceeds about 40 parts by weight, the thermoplastic resin composition can suffer from deterioration in flame retardancy, dimensional stability, isotropy, and the like.

In some embodiments, the talc and the flat plate type glass fibers may be present in a weight ratio (talc:flat plate type glass fiber) of about 1:2 to about 1:8, for example, about 1:2.5 to about 1:7. Within this range, the thermoplastic resin composition can have better dimensional stability, appearance characteristics, and the like.

### (G) Mica

The mica according to one embodiment of the present invention may be applied to the polycarbonate resin together with the polyester resin, the phosphate compound, the phosphazene compound, the phosphazene compound, the talc, the flat plate type glass fibers, and the like to improve flame retardancy, dimensional stability, isotropy, impact resistance, rigidity, appearance characteristics, property balance therebetween, and the like of the thermoplastic resin composition, and may include mica having an average particle diameter (D50) of about 250 μm to about 450 μm.

In some embodiments, the mica may have an average particle diameter (D50) of about 250 μm to about 450 μm, for example, about 300 μm to about 400 μm, as measured using a particle size analyzer (Malvern Mastersizer 3000). If the average particle diameter of the mica is less than about 250 μm, the thermoplastic resin composition can suffer from deterioration in dimensional stability, isotropy, and the like, and if the average particle diameter of the mica exceeds about 450 μm, the thermoplastic resin composition can suffer from deterioration in in terms of impact resistance, and the like.

In some embodiments, the mica may be present in an amount of about 1 to about 20 parts by weight, for example, about 5 to about 15 parts by weight, relative to about 100 parts by weight of the polycarbonate resin. If the content of the mica is less than about 1 part by weight relative to about 100 parts by weight of the polycarbonate resin, the thermoplastic resin composition can suffer from deterioration in isotropy and the like, and if the content of the mica exceeds about 20 parts by weight, the thermoplastic resin composition can suffer from deterioration in flame retardancy, impact resistance, and the like.

In some embodiments, the talc and the mica may be present in a weight ratio (talc:mica) of about 1:0.5 to about 1:2, for example, about 1:0.6 to about 1:1.9. Within this range, the thermoplastic resin composition can have better dimensional stability, isotropy, appearance characteristics, and the like.

In some embodiments, the flat plate type glass fibers and the mica may be present in a weight ratio (flat plate type glass fiber:mica) of about 1:0.1 to about 1:0.6, for example, about 1:0.1 to about 1:0.5. Within this range, the thermoplastic resin composition can have better dimensional stability, isotropy, rigidity, and the like.

The thermoplastic resin composition according to one embodiment of the present invention may further comprise additives included in typical thermoplastic resin compositions. The additives may include antioxidants, anti-dripping agents, lubricants, release agents, nucleating agents, antistatic agents, stabilizers, pigments, dyes, mixtures thereof, and the like, without being limited thereto. The additives may be present in an amount of about 0.001 to about 40 parts by weight, for example, about 0.1 to about 10 parts by weight, relative to about 100 parts by weight of the polycarbonate resin.

The thermoplastic resin composition according to one embodiment of the invention may be prepared in pellet form by mixing the aforementioned components, followed by melt extrusion at about 200° C. to about 300° C., for example, at about 230° C. to about 290° C., using a typical twin-screw extruder.

In some embodiments, the thermoplastic resin composition may have a flame retardancy of V-0 or higher, as measured on a 1.5 mm thick injection-molded specimen by the UL-94 vertical test method.

In some embodiments, the thermoplastic resin composition may have a coefficient of linear expansion of about 15 μm/m·° C. to about 36 μm/m·° C., for example, about 16 μm/m·° C. to about 35 μm/m·° C., as measured on an injection-molded specimen having a size of 10 mm×10 mm×3.2 mm while increasing temperature from −20° C. to 100° C. at 5° C./min in accordance with ASTM D696.

In some embodiments, the thermoplastic resin composition may have an isotropy of about 1.1 to about 1.3, as calculated according to Equation 1.

$$Isotropy = Coefficient of TD linear expansion / Coefficient of MD linear expansion \qquad [ Equation 1 ]$$

In Equation 1, the coefficient of TD linear expansion is a value measured on an injection-molded specimen having a size of 10 mm×10 mm×3.2 mm in a transverse direction (TD) and the coefficient of MD linear expansion is a value measured on the specimen in a machine direction (MD) while increasing temperature from −20° C. to 100° C. at 5° C./min in accordance with ASTM D696.

In some embodiments, the thermoplastic resin composition may have a notched Izod impact strength of about 5 kgf cm/cm to about 20 kgf cm/cm, for example, about 6 kgf cm/cm to about 15 kgf cm/cm, as measured on a ⅛″ thick specimen in accordance with ASTM D256.

In some embodiments, the thermoplastic resin composition may have a flexural modulus of about 70,000 kgf/cm² to about 140,000 kgf/cm², for example, about 75,000 kgf/cm² to about 130,000 kgf/cm², as measured on a 6.4 mm thick specimen at 2.8 mm/min in accordance with ASTM D790.

A molded article according to the present invention is formed of the thermoplastic resin composition. The thermoplastic resin composition may be prepared in pellet form and the prepared pellets may be produced into various molded articles (products) by various molding methods, such as injection molding, extrusion molding, vacuum molding, casting, and the like. These molding methods are well known to a person having ordinary knowledge in the art. The molded article has good properties in terms of flame retardancy, dimensional stability, isotropy, impact resistance, rigidity, appearance characteristics, property balance therebetween, and the like, and can be useful as interior/exterior materials for electrical and electronic products, thin film sheets, and the like.

In some embodiments, the molded article may be a plastic member of an electronic device housing comprising a metal frame and a plastic member adjoining at least one surface of the metal frame.

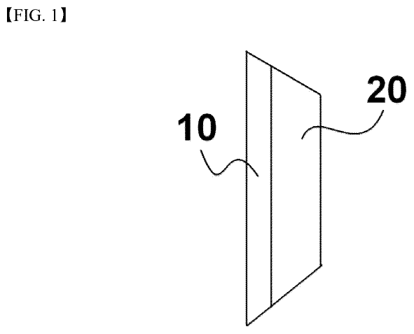

FIG. 1 is a schematic sectional view of a housing of an electronic product according to one embodiment of the present invention. It should be understood that the drawings are not to precise scale and the dimensions of components are exaggerated for clarity of description in the drawings. Referring to FIG. 1, the housing of an electronic product according to one embodiment includes a metal frame 10 and at least one plastic member 20 adjoining at least one surface of the metal frame 10, wherein the plastic member is formed of the thermoplastic resin composition according to the embodiments of the invention.

In some embodiments, the metal frame 10 and the plastic member 20 may have various shapes without being limited to the shapes shown in the drawings. The metal frame 10 and the plastic member 20 form an adjoining structure in which the metal frame 10 adjoins at least one surface of the plastic member 20. The adjoining structure may be realized by bonding or insertion, without being limited thereto.

In some embodiments, the metal frame 10 may be a stainless steel frame or may be selected from among any commercially available products, typically used for electronic product housings.

In some embodiments, the plastic member 20 may be formed of the polycarbonate resin composition by various molding methods, such as injection molding, extrusion molding, vacuum molding, casting, and the like. Specifically, the plastic member 20 may be formed by hot-water molding, steam molding (RHCM (rapid heat cycle molding)) or the like, and may be a front cover or a rear cover for 22″ to 85″ thin-film TVs, thin-film monitors, and the like. The plastic member 20 is applicable to external appearance specifications, such as a hairline pattern, a corrosion pattern, and the like.

### Mode for Invention

Next, the present invention will be described in more detail with reference to some examples. It should be understood that these examples are provided for illustration only and are not to be construed in any way as limiting the invention.

### EXAMPLE

Details of components used in Examples and Comparative Examples are as follows.

### (A) Polycarbonate Resin

A bisphenol-A type polycarbonate resin having a weight average molecular weight (Mw) of about 25,000 g/mol was used.

### (B) Polyester Resin

Polyethylene terephthalate (PET, manufacturer: Lotte Chemical Co., Ltd., intrinsic viscosity: about 0.765 dl/g) was used.

### (C) Phosphate Compound

Bisphenol-A diphosphate (manufacturer: Yoke Chemical Co., Ltd., product name: YOKE BDP) was used.

### (D) Phosphazene Compound

A phosphazene compound (manufacturer: Pharmicell Co., Ltd., product name: Phoretar) was used.

### (E) Talc

Talc having an average particle diameter (D50) of about 10 μm (manufacturer: KOCH, product name: KCP-04) was used.

### (F) Glass Fiber

(F1) Rectangular cross-sectional flat plate type glass fiber (manufacturer: Nittobo Co., Ltd., product name: CSG 3PA-832) having an aspect ratio (long-side length in cross-section/short-side length in cross-section) of about 4, a short-side length of about 7 μm, and a pre-processing length of about 3 mm was used.
(F2) Circular cross-sectional glass fiber (manufacturer: KCC Co., Ltd., product name: CS321-EC10-3) having a cross-section diameter of about 13 μm and a pre-processing length of about 3 mm was used.

### (G) Mica

(G1) Mica (manufacturer: KOCH, product name: M-50) having an average particle diameter (D50) of about 350 μm was used.
(G2) Mica having an average particle diameter (D50) of about 200 μm (manufacturer: KOCH, product name: M50-1) was used.
(G3) Mica having an average particle diameter (D50) of about 500 μm (manufacturer: KOCH, product name: M50-2) was used.

### Examples 1 to 13 and Comparative Examples 1 to 15

The aforementioned components were mixed in amounts as listed in Tables 1, 2, 3, 4, and 5, followed by extrusion at about 260° C., thereby preparing a thermoplastic resin composition in pellet form. Here, extrusion was performed using a twin-screw extruder (L/D: 36, diameter: 45 mm). The prepared pellets were dried at about 80° C. for about 4 hours or more and then subjected to injection molding using a 6 oz. injection machine (molding temperature: about 260° C., mold temperature: about 60° C.), thereby preparing a specimen. The prepared specimen was evaluated as to the following properties. Results are shown in Tables 1, 2, 3, 4, and 5.

### Property Evaluation

(1) Flame retardancy: Flame retardancy was measured on a 0.8 mm thick injection-molded specimen by the UL-94 vertical test method.
(2) Dimensional stability: Coefficient of linear expansion (unit: μm/m·° C.) was measured on an injection-molded specimen having a size of 10 mm×10 mm×3.2 mm while increasing temperature from −20° C. to 100° C. at 5° C./min using a thermomechanical analyzer in accordance with ASTM D696.
(3) Isotropy: Isotropy was calculated according to Equation 1.

$$Isotropy = Coefficient of TD linear expansion / Coefficient of MD linear expansion \qquad [ Equation 1 ]$$

In Equation 1, the coefficient of TD linear expansion is a value measured on an injection-molded specimen having a size of 10 mm×10 mm×3.2 mm in the transverse direction (TD) and the coefficient of MD linear expansion is a value measured on the specimen in the machine direction (MD) while increasing temperature from −20° C. to 100° C. at 5° C./min in accordance with ASTM D696.
(4) Impact resistance: Notched Izod impact strength (unit: kgf cm/cm) was measured on a ⅛″ thick specimen in accordance with ASTM D256.
(5) Rigidity: Flexural modulus (unit: kgf/cm²) was measured on a 6.4 mm thick specimen at 2.8 mm/min in accordance with ASTM D790.

TABLE 1

| | Example | | | | | | |
|---|---|---|---|---|---|---|---|
| | 1 | 2 | 3 | 4 | 5 | 6 | 7 |
| (A) (parts by weight) | 100 | 100 | 100 | 100 | 100 | 100 | 100 |
| (B) (parts by weight) | 1 | 3 | 10 | 3 | 3 | 3 | 3 |
| (C) (parts by weight) | 12 | 12 | 12 | 5 | 12 | 12 | 12 |
| (D) (parts by weight) | 8 | 8 | 8 | 8 | 8 | 5 | 10 |
| (E) (parts by weight) | 8 | 8 | 8 | 8 | 8 | 8 | 8 |
| (F1) (parts by weight) | 35 | 35 | 35 | 35 | 35 | 35 | 35 |
| (F2) (parts by weight) | — | — | — | — | — | — | — |
| (G1) (parts by weight) | 7 | 7 | 7 | 7 | 7 | 7 | 7 |
| (G2) (parts by weight) | — | — | — | — | — | — | — |
| (G3) (parts by weight) | — | — | — | — | — | — | — |
| Flame retardancy | V-0 | V-0 | V-0 | V-0 | V-0 | V-0 | V-0 |
| Coefficient of linear | 30 | 25 | 30 | 25 | 31 | 30 | 25 |
| expansion | | | | | | | |
| Isotropy (TD/MD) | 1.2 | 1.2 | 1.3 | 1.2 | 1.3 | 1.2 | 1.3 |
| Notched Izod impact strength | 9 | 11 | 6 | 13 | 6 | 12 | 8 |
| Flexural modulus | 100,000 | 110,000 | 110,000 | 120,000 | 95,000 | 110,000 | 100,000 |

TABLE 2

| | Example | | | | | |
|---|---|---|---|---|---|---|
| | 8 | 9 | 10 | 11 | 12 | 13 |
| (A) (parts by weight) | 100 | 100 | 100 | 100 | 100 | 100 |
| (B) (parts by weight) | 3 | 3 | 3 | 3 | 3 | 3 |
| (C) (parts by weight) | 12 | 12 | 12 | 12 | 12 | 12 |
| (D) (parts by weight) | 8 | 8 | 8 | 8 | 8 | 8 |
| (E) (parts by weight) | 5 | 10 | 8 | 8 | 8 | 8 |
| (F1) (parts by weight) | 35 | 35 | 20 | 40 | 35 | 35 |
| (F2) (parts by weight) | — | — | — | — | — | — |
| (G1) (parts by weight) | 7 | 7 | 7 | 7 | 5 | 15 |
| (G2) (parts by weight) | — | — | — | — | — | — |
| (G3) (parts by weight) | — | — | — | — | — | — |
| Flame retardancy | V-0 | V-0 | V-0 | V-0 | V-0 | V-0 |
| Coefficient of linear expansion | 31 | 25 | 35 | 18 | 30 | 18 |
| Isotropy (TD/MD) | 1.2 | 1.2 | 1.3 | 1.3 | 1.3 | 1.2 |
| Notched Izod impact strength | 13 | 6 | 12 | 12 | 12 | 12 |
| Flexural modulus | 100,000 | 120,000 | 75,000 | 130,000 | 115,000 | 125,000 |

TABLE 3

| | Comparative Example | | | | | |
|---|---|---|---|---|---|---|
| | 1 | 2 | 3 | 4 | 5 | 6 |
| (A) (parts by weight) | 100 | 100 | 100 | 100 | 100 | 100 |
| (B) (parts by weight) | 0.1 | 0.1 | 3 | 3 | 3 | 3 |
| (C) (parts by weight) | 12 | 12 | 1 | 20 | 12 | 12 |
| (D) (parts by weight) | 8 | 8 | 8 | 8 | 0.5 | 20 |
| (E) (parts by weight) | 8 | 8 | 8 | 8 | 8 | 8 |
| (F1) (parts by weight) | 35 | 35 | 35 | 35 | 35 | 35 |
| (F2) (parts by weight) | — | — | — | — | — | — |
| (G1) (parts by weight) | 7 | 7 | 7 | 7 | 7 | 7 |
| (G2) (parts by weight) | — | — | — | — | — | — |
| (G3) (parts by weight) | — | — | — | — | — | — |
| Flame retardancy | V-0 | V-2 | V-2 | V-0 | V-2 | V-0 |
| Coefficient of linear expansion | 40 | 35 | 25 | 35 | 25 | 35 |
| Isotropy (TD/MD) | 1.4 | 1.9 | 1.2 | 1.7 | 1.2 | 1.6 |
| Notched Izod impact strength | 12 | 3 | 13 | 4 | 12 | 4 |
| Flexural modulus | 100,000 | 120,000 | 120,000 | 80,000 | 110,000 | 80,000 |

TABLE 4

| | Comparative Example | | | | |
|---|---|---|---|---|---|
| | 7 | 8 | 9 | 10 | 11 |
| (A) (parts | 100 | 100 | 100 | 100 | 100 |
| by weight) | | | | | |
| (B) (parts | 3 | 3 | 3 | 3 | 3 |
| by weight) | | | | | |
| (C) (parts | 12 | 12 | 12 | 12 | 12 |
| by weight) | | | | | |
| (D) (parts | 8 | 8 | 8 | 8 | 8 |
| by weight) | | | | | |
| (E) (parts | 0.5 | 20 | 8 | 8 | 8 |
| by weight) | | | | | |
| (F1) (parts | 35 | 35 | 5 | 45 | — |
| by weight) | | | | | |
| (F2) (parts | | | — | — | 35 |
| by weight) | | | | | |
| (G1) (parts | 7 | 7 | 7 | 7 | 7 |
| by weight) | | | | | |
| (G2) (parts | | | — | — | — |
| by weight) | | | | | |
| (G3) (parts | | | — | — | — |
| by weight) | | | | | |
| Flame | V-0 | V-2 | V-0 | V-1 | V-0 |
| retardancy | | | | | |
| Coefficient | 32 | 22 | 55 | 13 | 12 |
| of linear | | | | | |
| expansion | | | | | |
| Isotropy | 1.7 | 1.3 | 2.1 | 1.4 | 1.5 |
| (TD/MD) | | | | | |
| Notched | 11 | 3 | 20 | 9 | 9 |
| Izod impact | | | | | |
| strength | | | | | |
| Flexural | 99,000 | 115,000 | 35,000 | 140,000 | 120,000 |
| modulus | | | | | |

TABLE 5

| | Comparative Example | | | |
|---|---|---|---|---|
| | 12 | 13 | 14 | 15 |
| (A) (parts by weight) | 100 | 100 | 100 | 100 |
| (B) (parts by weight) | 3 | 3 | 3 | 3 |
| (C) (parts by weight) | 12 | 12 | 12 | 12 |
| (D) (parts by weight) | 8 | 8 | 8 | 8 |
| (E) (parts by weight) | 8 | 8 | 8 | 8 |
| (F1) (parts by weight) | 35 | 35 | 35 | 35 |
| (F2) (parts by weight) | — | — | — | — |
| (G1) (parts by weight) | 0.1 | 20 | — | — |
| (G2) (parts by weight) | — | — | 7 | — |
| (G3) (parts by weight) | — | — | — | 7 |
| Flame retardancy | V-0 | V-1 | V-0 | V-0 |
| Coefficient of linear | 35 | 20 | 37 | 25 |
| expansion | | | | |
| Isotropy (TD/MD) | 1.6 | 1.2 | 1.4 | 1.2 |
| Notched Izod impact | 12 | 4 | 14 | 4 |
| strength | | | | |
| Flexural modulus | 100,000 | 120,000 | 110,000 | 110,000 |

From the above results, it could be seen that the thermoplastic resin compositions of the present invention had good properties in terms of flame retardancy, dimensional stability (coefficient of linear expansion), isotropy (coefficient of TD linear expansion/coefficient of MD linear expansion), impact resistance (notched Izod impact strength), rigidity (flexural modulus), and appearance characteristics.

Conversely, it could be seen that the thermoplastic resin composition prepared using an insufficient amount of the polyester resin (Comparative Example 1) suffered from deterioration in dimensional stability, isotropy, and the like, and the thermoplastic resin composition prepared using an excess of the polyester resin (Comparative Example 2) suffered from deterioration in flame retardancy, isotropy, impact resistance, and the like. It could be seen that the thermoplastic resin composition prepared using an insufficient amount of the phosphate compound (Comparative Example 3) suffered from deterioration in flame retardancy and the like, and the thermoplastic resin composition prepared using an excess of the phosphate compound (Comparative Example 4) suffered from deterioration in isotropy, impact resistance, and the like. It could be seen that the thermoplastic resin composition prepared using an insufficient amount of the phosphazene compound (Comparative Example 5) suffered from deterioration in flame retardancy and the like, and the thermoplastic resin composition prepared using an excess of the phosphazene compound (Comparative Example 6) suffered from deterioration in isotropy, impact resistance, and the like. It could be seen that the thermoplastic resin composition prepared using an insufficient amount of the talc (Comparative Example 7) suffered from deterioration in isotropy and the like, and the thermoplastic resin composition prepared using an excess of the talc (Comparative Example 8) suffered from deterioration in flame retardancy, impact resistance, and the like. It could be seen that the thermoplastic resin composition prepared using an insufficient amount of the flat plate type glass fibers (Comparative Example 9) suffered from deterioration in dimensional stability, isotropy, rigidity, and the like, the thermoplastic resin composition prepared using an excess of the flat plate type glass fibers (Comparative Example 10) suffered from deterioration in flame retardancy, dimensional stability, isotropy, and the like, and the thermoplastic resin composition prepared using circular glass fibers (F2) (Comparative Example 11) instead of the flat plate type glass fibers of the present invention suffered from deterioration in dimensional stability, isotropy, and the like. In addition, it could be seen that the thermoplastic resin composition prepared using an insufficient amount of the mica (Comparative Example 12) suffered from deterioration in isotropy and the like, the thermoplastic resin composition prepared using an excess of the mica (Comparative Example 13) suffered from deterioration in flame retardancy, impact resistance, and the like, the thermoplastic resin composition prepared using mica (G2) (Comparative Example 14) instead of the mica of the present invention suffered from deterioration in dimensional stability, isotropy, and the like, and the thermoplastic resin composition prepared using mica (G3) (Comparative Example 15) instead of the mica of the present invention suffered from deterioration in impact resistance, and the like.

Although some embodiments have been described herein, it will be understood by those skilled in the art that various modifications, changes, and alterations can be made without departing from the spirit and scope of the invention. Therefore, it should be understood that these embodiments are provided for illustration only and are not to be construed in any way as limiting the present invention. The scope of the present invention should be defined by the appended claims rather than by the foregoing description, and the claims and equivalents thereto are intended to cover such modifications and the like as would fall within the scope of the present invention.

1. A thermoplastic resin composition comprising:
about 100 parts by weight of a polycarbonate resin;
about 0.5 parts by weight to about 15 parts by weight of a polyester resin;
about 1 part by weight to about 20 parts by weight of a phosphate compound;
about 1 part by weight to about 15 parts by weight of a phosphazene compound;
about 1 part by weight to about 15 parts by weight of talc having an average particle diameter (D50) of about 7 μm to about 20 μm;
about 10 parts by weight to about 40 parts by weight of flat plate type glass fibers; and
about 1 part by weight to about 20 parts by weight of mica having an average particle diameter (D50) of about 250 μm to about 450 μm.

2. The thermoplastic resin composition according to claim 1, wherein the polyester resin comprises at least one of polyethylene terephthalate, polybutylene terephthalate, polyethylene naphthalate, polytrimethylene terephthalate, and polycyclohexylene terephthalate.

3. The thermoplastic resin composition according to claim 1, wherein the flat plate type glass fibers have a cross-section aspect ratio (long-side length in cross-section/short-side length in cross-section) of about 1.5 to about 10, a cross-section diameter of about 2 μm to about 10 μm, and a pre-processing length of about 1 mm to about 30 mm.

4. The thermoplastic resin composition according to claim 1, wherein the phosphate compound and the phosphazene compound are present in a weight ratio of about 1:0.3 to about 1:2.

5. The thermoplastic resin composition according to claim 1, wherein the talc and the flat plate type glass fibers are present in a weight ratio of about 1:2 to about 1:8.

6. The thermoplastic resin composition according to claim 1, wherein the talc and the mica are present in a weight ratio of about 1:0.5 to about 1:2.

7. The thermoplastic resin composition according to claim 1, wherein the flat plate type glass fibers and the mica are present in a weight ratio of about 1:0.1 to about 1:0.6.

8. The thermoplastic resin composition according to claim 1, wherein the thermoplastic resin composition has a flame retardancy of V-0 or higher, as measured on a 1.5 mm thick injection molded-specimen by a UL-94 vertical test method

9. The thermoplastic resin composition according to claim 1, wherein the thermoplastic resin composition has a coefficient of linear expansion of about 15 μm/m·° C. to about 36 μm/m·° C., as measured on an injection-molded specimen having a size of 10 mm×10 mm×3.2 mm while increasing temperature from −20° C. to 100° C. at 5° C./min in accordance with ASTM D696.

10. The thermoplastic resin composition according to claim 1, wherein the thermoplastic resin composition has an isotropy of about 1.1 to about 1.3, as calculated according to Equation 1.
Isotropy=Coefficient of TD linear expansion/Coefficient of MD linear expansion [Equation 1]
where the coefficient of TD linear expansion is a value measured on an injection-molded specimen having a size of 10 mm×10 mm×3.2 mm in a transverse direction (TD) and the coefficient of MD linear expansion is a value measured on the specimen in a machine direction (MD) while increasing temperature from −20° C. to 100° C. at 5° C./min in accordance with ASTM D696.

11. The thermoplastic resin composition according to claim 1, wherein the thermoplastic resin composition has a notched Izod impact strength of about 5 kgf cm/cm to about 20 kgf cm/cm, as measured on a ⅛″ thick specimen in accordance with ASTM D256.

12. The thermoplastic resin composition according to claim 1, wherein the thermoplastic resin composition has a flexural modulus of about 70,000 kgf/cm² to about 140,000 kgf/cm², as measured on a 6.4 mm thick specimen at 2.8 mm/min in accordance with ASTM D790.

13. A molded article formed of the thermoplastic resin composition according to claim 1.

14. The molded article according to claim 13, wherein the molded article is a plastic member of an electronic device housing comprising a metal frame and a plastic member adjoining at least one surface of the metal frame.
